(19) United States
(12) Patent Application Publication
(10) Pub. No.: US 2007/0181646 A1
(43) Pub. Date: Aug. 9, 2007

(54) Friction Stir Welding Method

(76) Inventor: Kinya Aota, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/624,237

(22) Filed: Jan. 18, 2007

(30) Foreign Application Priority Data
Feb. 7, 2006 (JP) 2006-029109

(51) Int. Cl. A47J 36/02

(52) U.S. Cl. 228/101

(57) ABSTRACT

The present invention provides a friction stir welding method in which a plurality of members are lapped and a welding tool is pressed into one of the members, while being rotated, to cause friction stir to weld the members. A small diameter projected part is disposed at a tip end of a shoulder of the welding tool, and is positioned out of a rotating axis of the welding tool. Especially, the method is suitable for spot welding and removes a surface oxidation film on a lapped welding interface to weld two members.

### BACKGROUND OF THE INVENTION

(1) Technical Field

The present invention relates to a friction stir welding technique for welding a plurality of lapped members to form a lap joint.

(2) Description of related art

Conventional technology for welding a plurality of lapped members to form a lap joint using a friction stir welding technique includes a method disclosed in JP-A-2005-161382, for example. JP-A-2005-161382 discloses a welding tool having a planar tip surface or a tip surface with a concave part. It is pressed into one member to be welded to cause friction stir on the side of the one member, and thus, a plastic flow is caused so that it is welded with the other member.

Furthermore, the friction stir welding disclosed in JP-B2-3452044 is also known, for example, in which friction stir is provided by decentering a pin at a tip end of a welding tool from a rotating axis of the tool.

### SUMMARY OF THE INVENTION

Regarding a friction stir welding, JA-A-2005-161382 discloses a method in which a plurality lapped members are welded together, wherein a welding tool is pressed into one of the members, while being rotated, so as to cause friction stir to weld them. This welding method is such that the plastic flow in the member to be welded removes a surface oxidation film of weld interface so as to activate the interface, so that the members are welded. Since the center of a welding part has a zero peripheral velocity, however, the plastic flow cannot remove the surface oxidation film on the lapped surfaces at the welding center. Therefore, a problem is raised that an unwelded portion may be remained.

Furthermore, in the method disclosed in JP-B2-3452044, a sufficient peripheral velocity is not still provided at the center of the welding part, and thus the surface oxidation film on the lapped surfaces at the welding center cannot be removed by the plastic flow. Accordingly, a problem is also raised that an unwelded portion may be remained.

Therefore, an object of the present invention is to provide a friction stir welding method for preventing an unwelded portion at the center of a welding interface.

One aspect of the present invention provides a friction stir welding method comprising: lapping a plurality of members; and pressing a welding tool into one of the members, while being rotated, to cause friction stir to welded them, wherein a small diameter projected part is disposed at a tip end of a shoulder of the welding tool, and is positioned out of a rotating axis of the welding tool.

Another aspect of the invention provides a friction stir welding tool including a projected part having a small diameter disposed at a tip end of a shoulder, wherein the projected part is positioned out of a rotating axis of the welding tool.

Further aspect of the invention provides a friction stir welding apparatus comprising a welding tool including a projected part having a small diameter, which is disposed at a tip end of a shoulder and is positioned out of a rotating axis of a welding tool.

In these aspects, the projected part preferably has a semispherical shape and a minimum angle between an imaginary tangent line at a point on the surface of the projected part and the rotating axis of the welding tool is in a range of 45 to 90 degrees.

A plurality of projected parts may be provided at the tip end of the shoulder of the welding tool. Also, the projected part may have an elliptical shape.

The invention is preferably applied for spot welding, in which a plurality of members are lapped and the welding tool is pressed into one of the members, while being rotated, to welded them together due to friction stir caused thereby.

According to the friction stir welding method using the welding tool of the invention, a plastic flow can be caused at the rotation center of the welding tool to provide good welding without an unwelded portion.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 shows a first example of a welding method in the invention;

FIG. 2 shows a plastic flow model in cross-section taken along the line A-B of the first example;

FIG. 3A is a front elevation of a welding tool of the first example;

FIG. 3B is a side elevation of the welding tool of the first example;

FIG. 4A is a front elevation of a welding tool 1 of a second example;

FIG. 4B is a side elevation of the welding tool 1 of the second example;

FIG. 5A is a front elevation of a welding tool of a third example;

FIG. 5B is a side elevation of the welding tool of the third example;

FIG. 6A is a front elevation of a welding tool 1 of a fourth example; and

FIG. 6B is a side elevation of the welding tool 1 of the fourth example.

### DETAILED DESCRIPTION OF THE INVENTION

In a friction stir welding method in the invention, a projected part with a small diameter is disposed at a tip end of a shoulder of a welding tool, and the projected part is positioned at a portion closer to a periphery than a rotating axis of the welding tool.

When the projected part is rotated, for example by θ degrees, due to rotation of the welding tool, a welding member situated at a position of the projected part after rotation by θ degrees flows in a form of a plastic flow to fill a previous position before the rotation by θ degrees.

At this time, the plastic flow occurs along the circumference of the projected part. Thus, rotation of the welding tool allows a welding interface at the center of a welding part to flow plastically.

Preferably, this projected part has a semispherical shape. This is because it becomes easy to fill the portion corresponding to the position of the projected part before the rotation by θ degrees.

Preferably, a minimum angle between an imaginary tangent line at a point on the surface of the projected part and the rotating axis of the welding tool is in a range of 45 to 90 degrees. This is also because it becomes easy to fill the portion corresponding to the position of the projected part before the rotation by θ degrees.

When the pin on the welding tool is made eccentric while the pin is still disposed at the rotation center of the welding tool, a sufficient plastic flow cannot be provided at the center and an unwelded portion may be formed. In the example of the invention, on the other hand, a rotational flow along the pin is caused, which flows plastically at the center, so that the above problems are solved.

### EXAMPLE 1

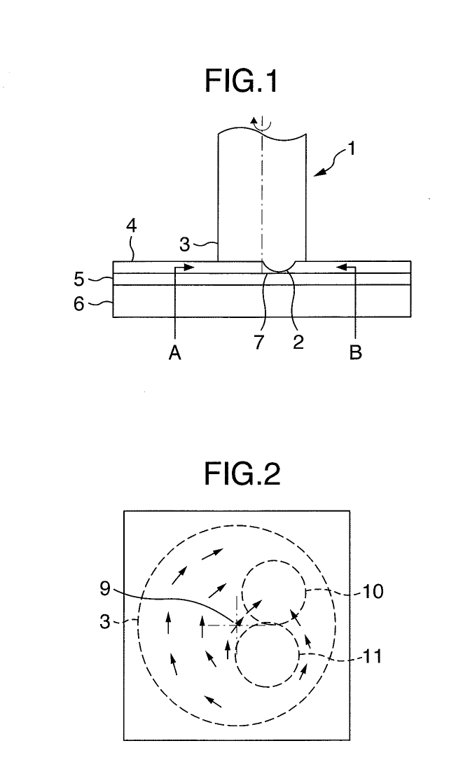

FIG. 1 shows a welding method of a first example of the invention. A welding tool 1 has a small diameter projected part 2 at a tip end of a large diameter shoulder 3. The projected part 2 is positioned closer to a periphery than a rotating axis of the welding tool 1.

Furthermore, an upper plate 4 and a lower plate 5, as test pieces to be welded, are lapped and placed on a supporting member 6.

In this example, the upper plate 4 is made of pure aluminum for industrial use, and the lower plate 5 is made of nickel. The upper plate 4 and the lower plate 5 made of different materials from one another are welded. In this example, it becomes possible to easily weld plates made of different materials from one another, and it is especially suitable for spot welding. The supporting member 6 is made of a tool steel. The upper plate 4 and the lower plate 5 have a thickness of 0.4 mm, respectively.

Whether the upper plate 4 and lower plate 5 are made of the same metal or different kinds of metals, they can be welded. Especially, the upper plate 4 is preferably made of a metal having a low melting point such as aluminum, lead, tin or magnesium.

When metals having largely different melting points from each other are welded, a high welding temperature tends to create a thick reaction layer on a welding interface 7 between them. In such a case, a metal having a lower melting point is preferably used for the upper plate 4 in welding, by which the welding temperature is lowered, and a thickness of the reaction layer could be minimized.

This method is especially effective when metals having largely different melting points from each other, such as aluminum and nickel, are welded.

When the upper plate 4 is made of aluminum and the lower plate 5 is made of a steel, it is also effective to coat a surface of the steel with nickel. It is because nickel is a soft metal and easily deformed plastically, and a surface oxidation film is easily peeled. Zinc coating or cu coating also provides the same effect.

The welding tool 1 is made of a tool steel. The shoulder 3 has a diameter of 5 mm. The projected part 2 has a diameter of 1 mm and a height of 0.3 mm, and the center of the projected part 2 is located away by 1 mm from the rotation center of the welding tool 1. Due to these arrangements, the projected part 2 does not cover the rotation center of the welding tool 1. Spot welding is carried out as follows: the welding tool 1 is rotated at 18,000 rpm and pressed into the upper plate 4 at the rate of 60 mm/min; the state is kept for 100 ms; and then it is pulled out at a rate of 120 mm/min.

In this case, the upper plate 4 is forced to flow plastically to remove a surface oxidation film at the interface 7 of the lapped members, and both members, the upper plate 4 and the lower plate 5, are welded.

The projected part 2 has a semispherical shape.

Although the projected part 2 is positioned away by 1 mm from the rotation center of the welding tool 1 in this example, it may contact the rotation center. However, not limited to this example, the projected part 2 is preferably required to be positioned outward by about 0.1 to about 1 mm from the rotation center of the welding tool 1.

Furthermore, the projected part 2 is required to be formed inside, by about 0.1 to about 1.0 mm, from the peripheral of the welding tool 1.

That is, the diameter of the projected part 2 is required to be shorter than the radius of the welding tool 1.

FIG. 2 shows a plastic flow model in cross-section taken along the line A-B of FIG. 1. Dashed lines therein denote the shoulder 3 and the projected part 2. It is assumed that the projected part 2 is displaced from a position 10 to a position 11 when the welding tool 1 is rotated by θ degrees.

At this time, in a region where the projected part 2 is absent, a plastic flow is caused in the rotational direction of the welding tool 1. Since the projected part 2 is displaced from the initial position 10 before rotation to the position 11 after rotation, a plastic flow is caused along the outer circumference of the projected part 2, and the plastic flow is also caused at the rotation center 9 of the welding tool 1. Thus, a surface oxidation film on a welding interface is removed also at the rotation center 9 so that highly reliable welding is possible.

When the center of a pin formed at a tip end of a welding tool is positioned at the rotation center of the welding tool, as a comparative example, a peripheral velocity at the center of the welding part becomes zero, so that a plastic flow is not caused there and it results in failing of welding.

When a pin formed at a tip end of a welding tool is positioned at a position different from the rotation center of the welding tool, but a part of the pin is positioned at the rotation center of the welding tool, as another comparative example, a plastic flow is not also caused there, and it also results in failing of welding.

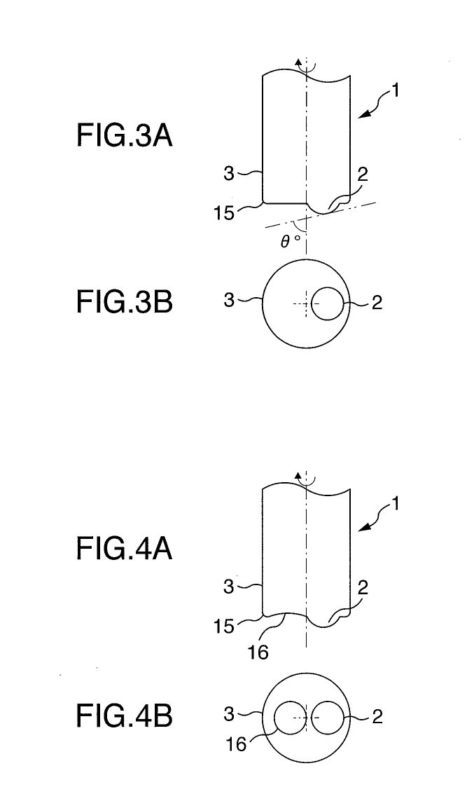

FIGS. 3A and 3B show a side view and front view of a welding tool of this example, respectively.

A shape of the projected part 2 formed on the welding tool 1 is preferably semispherical, and especially, a minimum angle θ between an imaginary tangent line thereof and the rotating axis of the welding tool 1 is preferably in a range of 45 to 90 degrees.

It has been founded that, when the angle θ becomes smaller, a volume of the projected part becomes larger and a region where the projected part has passed through may not be fully filled due to a plastic flow during welding, which may cause a cavity defect.

Preferably, a corner 15 at a peripheral of the shoulder 3 is shaped to have a curvature.

Table 1 shows a relationship between the minimum tangent angle θ and the defect, showing an occurrence of the defect. It was found that in a range of 45 to 90 degrees, the defect did not occur and good welding could be achieved.

TABLE 1

| Minimum Tangent Angle θ | Defect |
|---|---|
| 0 | Occurred |
| 15 | Occurred |
| 30 | Occurred |
| 45 | Not occurred |
| 60 | Not occurred |
| 75 | Not occurred |
| 90 | Not occurred |

### When the minimum tangent angle θ is in a range of 0 to 30 degrees, the defect occurred and good welding could not be obtained.

### EXAMPLE 2

FIGS. 4A and 4B show a shape of a welding tool of a second example. The welding tool 1 is provided with a concave part 16A, which is different from the tool in the example 1. Even though the concave part 16 is present, an effect of the present invention may be provided.

### EXAMPLE 3

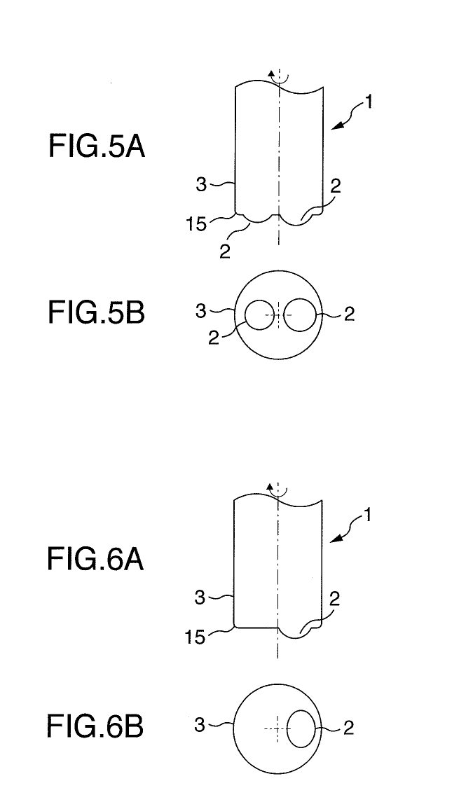

FIGS. 5A and 5B show a shape of a welding tool of a third example. The welding tool 1 is provided with two projected parts 2, which is different from the tool in the example 1. Even though a plurality of the projected parts 2 are present, an effect of the present invention may be provided.

### EXAMPLE 4

FIGS. 6A and 6B show a shape of a welding tool 1 of a fourth example. A projected part 2 formed on the welding tool 1 has an elliptical shape, which is different from the tool in the example 1. Even though it has an elliptical shape, an effect of the present invention may be provided.

The present invention relates to a friction stir welding method, and is especially useful in a technical field of friction stir welding using spot welding. Especially, it is widely available in such a field.

It should be further understood by those skilled in the art that although the foregoing description has been made on embodiments of the invention, the invention is not limited thereto and various changes and modifications may be made without departing from the spirit of the invention and the scope of the appended claims.

1. A friction stir welding method comprising: lapping a plurality of members to be welded; and pressing a welding tool into one of the members, while the welding tool being rotated, to cause friction stir to weld the members,
wherein the welding tool includes a projected part having a small diameter at a tip end of a shoulder, the projected part being positioned out of a rotating axis of the welding tool.

2. The method according to claim 1, wherein the projected part has a semispherical shape.

3. The method according to claim 1, wherein a minimum angle between an imaginary tangent line at a point on the surface of the projected part and the rotating axis of the welding tool is in a range of 45 to 90 degrees.

4. The method according to claim 1, wherein the welding tool have a plurality of projected parts.

5. The method according to claim 1, wherein the projected part has an elliptical shape.

6. A friction stir welding tool for welding a plurality of lapped members, the welding tool being pressed into one of the members, while the welding tool being rotated, to cause friction stir to weld the members,
wherein the welding tool includes a projected part with a small diameter at a tip end of a shoulder, the projected part being positioned out of a rotating axis of the welding tool.

7. The welding tool according to claim 6, wherein the projected part has a semispherical shape.

8. The welding tool according to claim 6, wherein a minimum angle between an imaginary tangent line at a point on the surface of the projected part and the rotating axis of the welding tool is in a range of 45 to 90 degrees.

9. The welding tool according to claim 6, wherein the welding tool have a plurality of projected parts.

10. The welding tool according to claim 6, wherein the projected part has an elliptical shape.

11. A friction stir welding apparatus for welding a plurality of lapped members, the apparatus comprising a welding tool pressed into one of the members, while the welding tool being rotated, to cause friction stir to weld the members,
wherein the welding tool includes a projected part having a small diameter at a tip end of a shoulder, the projected part being positioned out of a rotating axis of the welding tool.

12. The welding apparatus according to claim 11, wherein the projected part has a semispherical shape.

13. The welding apparatus according to claim 11, wherein a minimum angle between an imaginary tangent line at a point on the surface of the projected part and the rotating axis of the welding tool is in a range of 45 to 90 degrees.

14. The welding apparatus according to claim 11, wherein the welding tool have a plurality of projected parts.

15. The welding apparatus according to claim 11, wherein the projected part has an elliptical shape.
